(19) United States
(12) Patent Application Publication
(10) Pub. No.: US 2023/0085763 A1
(43) Pub. Date: Mar. 23, 2023

(54) METHOD AND SYSTEM FOR UNIFIED SOCIAL MEDIA ECOSYSTEM WITH SELF VERIFICATION AND PRIVACY PRESERVING PROOFS

(71) Applicant: Abilash Soundararajan, Bangalore (IN)

(72) Inventor: Abilash Soundararajan, Bangalore (IN)

(21) Appl. No.: 17/759,520

(22) PCT Filed: Aug. 3, 2020
(86) PCT No.: PCT/IB2020/057321

§ 371 Date: Jul. 27, 2022

(30) Foreign Application Priority Data
Jan. 30, 2020 (IN) 202041004087

(51) Int. Cl. G06Q 50/26; G06Q 50/00; G06F 21/62

(52) U.S. Cl. CPC G06Q 50/265; G06Q 50/01; G06F 21/6245

(57) ABSTRACT

A method and system for unified social media ecosystem with secure self-verification and privacy preserving proofs is disclosed. The system includes a user identity mapping subsystem, a pseudonymous identity and shared information subsystem, a harmful content reporting subsystem and a reported harmful content verification subsystem. The system is also characterised by a unified social media platforms exchange subsystem. The unified social media platforms exchange subsystem enables easy identification of social media platforms containing the harmful information, easy identification of the platform of primary harmful content origin, easy deletion the verified harmful information across corresponding identified social media platform, easy deletion the verified harmful information across social media ecosystem, easy notification of time-stamp details of all the participant platforms, identification of the pseudonymous identity of the originator of harmful content across platforms and subsequently identification of the personal identifiable information of the originator, using secure self-verification and privacy preserving proofs.

### CROSS-REFERENCE TO RELATED APPLICATION

This application claims priority from a patent application filed in India having Patent Application No. 202041004087, filed on Jan. 30, 2020, and titled “SYSTEM FOR A PRIVACY COMPLIANT UNIFIED SOCIAL MEDIA ECOSYSTEM INTEGRATING STAKEHOLDERS IN A GEOGRAPHY” and a PCT Application No. PCT/IB2020/057321 filed on 3 Aug. 2020, and titled “METHOD AND SYSTEM FOR UNIFIED SOCIAL MEDIA ECOSYSTEM WITH SELF VERIFICATION AND PRIVACY PRESERVING PROOFS”.

### FIELD OF INVENTION

Embodiments of the present disclosure relate to ecosystem level harmful information origin identification and removal system, and more particularly, to a privacy compliant unified Social media platform ecosystem integrating stakeholders with secure self-verification and privacy preserving proofs.

### BACKGROUND

Every minute, people around the world are posting pictures, videos, tweeting and otherwise communicating about all sorts of events and happenings. However, lot of the information shared on the social media are criminal or harmful in nature. Harmful information in the social media constitute a potential threat to public.

Social Media is defined as forms of electronic communication, such as websites and apps for social networking and content sharing, through which users create online communities to share information, ideas, personal messages and other content in various formats, using communication mediums with access ranging from public access to restricted access to end to end encrypted platforms.

At present, social media platforms have two options which is either anonymity or complete exposure of user identity and information. Because of the limited options, the social media platforms either end up giving privacy to people with malicious intent such as terrorist or end up exposing messages and identity of genuine users which are bad.

One such scenario may be spreading harmful information about child abuse. CSAM, online sexual harassment, deep fake, financial frauds, healthcare frauds, online blackmailing, obscenity, true threats, content instigating immediate violence and other content harmful to society. Also, a plurality of users is spreading the same harmful information by sharing the harmful information to other users via Social media platform. In a similar manner, the plurality of scenarios makes it difficult to identify the falseness or harmfulness of information.

Criminal content, Misinformation and Mal-information are creating anarchy across democracies of the world. The virality of social media is causing rapid spread of harmful content in societies, which judiciary or law enforcement agencies are not able to control, as they are caught between privacy violation of masses and preventing spread of harmful content in social media. Supreme court of India has acknowledged that fake news and harmful content in social media has taken a dangerous turn and has to be addressed, which is a scientific problem, but no privacy compliant technology exists as of today. Just a technical solution would not suffice as a privacy complaint collaboration framework is also required for various stake holders to work together to ensure social media is kept clean of harmful content.

Hence, there is a need for an improved privacy compliant unified social media platform ecosystem integrating stakeholders with self-verification and privacy preserving proof and a method to operate the same and therefore address the aforementioned issues.

### BRIEF DESCRIPTION

In accordance with one embodiment of the disclosure, a system for unified social media ecosystem with self-verification and privacy preserving proofs is disclosed. The system includes a user identity mapping subsystem. The user identity mapping subsystem is configured in a computing system operable by a processor and configured to store a personally identifiable information and a pseudonymous identity associated with registered users upon registration in a corresponding social media platform.

The system also includes a pseudonymous identity and shared information subsystem. The pseudonymous identity and shared information subsystem is configured in the computing system operable by the processor and operatively coupled to the user identity mapping subsystem. The pseudonymous identity and shared information subsystem is configured to capture pseudonymous cryptographic commitments, where some of the attributes may be a pseudonymous identity of an originator of an information in the Social media platform, a pseudonymous identity of each information upon sharing the information on the social media platform, time stamp of information sharing, content status like active, deleted or flagged and information of the external platform if it is an external share, which may be managed centrally or distributed.

The system also includes a harmful content reporting subsystem. The harmful content reporting subsystem is configured in the computing system operable by the processor and operatively coupled to the pseudonymous identity and shared information subsystem. The harmful content reporting subsystem is configured to record reported harmful information by a known or anonymous user without knowing information about the pseudonymous identity of the originator of information. The system also includes a reported harmful content verification subsystem. The reported harmful content verification subsystem is configured in the computing system operable by the processor and operatively coupled to the harmful content reporting subsystem. The reported harmful content verification subsystem is configured to receive verification associated with a reported harmful information from one or multiple entities without knowledge of originator or reporter.

The system also includes a unified social media platforms exchange subsystem. The unified social media platforms exchange subsystem is operable by the processor and configured to identify the social media platforms containing the verified harmful information based on the captured pseudonymous identity of the verified harmful information without leaking any other information. The unified social media platforms exchange subsystem is also configured to delete the verified harmful information across corresponding identified Social media platform without leaking any other information. The unified social media platforms exchange subsystem is also configured to delete the verified harmful information across social media ecosystem so as to prevent spreading of the verified harmful information without leaking any other information.

The unified social media platforms exchange subsystem is also configured to notify time-stamp details of all the participant platforms of the verified harmful information to law enforcement subsystem without leaking any other information. The unified social media platforms exchange subsystem is also configured to identify and notify the pseudonymous identity of the originator of harmful content across platforms and subsequently identify the personally identifiable information of the originator in relation to the verified harmful information and securely disclose it to authorized entity only after receiving digital verification proofs from all necessary entities, without leaking of any other information to any other entity.

The unified social media platform ecosystem provides ability for authorized stakeholders to do secure self-verification resulting in privacy preserving proofs generated by subsystems following interactions. The resulting privacy preserving proofs can also be self-verified. Secure self-verification is a process and Privacy preserving proof is a digitally verifiable proof. Secure self-verification is done by authorized entities to verify automatically in a trustworthy way and generate privacy preserving proofs, proving exactly what is needed and without leaking any other information during the entire process, even in case of collusion. Conversely, an existing proof may also be verified by another entity. Hence a secure self-verification may be used for both creation and verification of privacy preserving proofs.

In accordance with one embodiment of the disclosure, a method of operating unified social media ecosystem with self-verification and privacy preserving proofs is disclosed. The method includes storing a personally identifiable information and a pseudonymous identity associated with registered users upon registration in a corresponding social media platform. The method also includes capturing a pseudonymous cryptographic commitment, either centrally or distributed method, where some of the attributes may be a pseudonymous identity of an originator of an information in the social media platform and a pseudonymous identity of each information upon sharing the information on the social media platform.

The method also includes recording anonymously reporting harmful information by a reporter without knowing any information about originator or circulating platforms. The method also includes verifying a reported harmful information by single or multiple verifiers without knowledge of originator or reporter upon receiving confirmation that the message was shared within social media platforms.

The method also includes identifying the social media platform reported for circulation of harmful information based on the captured pseudonymous identity of the verified harmful information. The method also includes deleting the verified harmful information across a corresponding identified social media platform. The method also includes deleting or taking other recommended action the verified harmful information across social media ecosystem so as to prevent spreading.

The method also includes notifying time-stamp details of the verified harmful information to law enforcement subsystem. The method also includes notifying the stored pseudonymous identity as well as the stored personally identifiable information of the originator in relation to the verified harmful information to the law enforcement subsystem and judiciary subsystem. The method also includes secure self-verification of different types of compliance and generation of privacy preserving proofs.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 (a) is a block diagram representation of unified social media ecosystem with self-verification and Privacy preserving proofs in accordance with an embodiment of the present disclosure.

FIG. 1 (b) is a block diagram representing integration of stakeholders in a social media platform ecosystem enabling secure self-verifications, generate and verify privacy preserving proofs amongst participants and based on their authorization.

FIG. 2 is a schematic representation of steps taken to securely self-verify by interacting with the platforms and generating privacy preserving proofs to identify the social media platforms containing the verified harmful information in accordance with an embodiment of the present disclosure.

FIG. 3 is a schematic representation of steps taken to securely self-verify by interacting with the platforms and generating privacy preserving proofs to delete the verified harmful information across corresponding identified Social media platform without leaking any other in accordance with an embodiment of the present disclosure.

FIG. 4 is a schematic representation of steps taken to securely self-verify by interacting with the platforms and generating privacy preserving proofs to delete the verified harmful information across social media ecosystem so as to prevent spreading of the verified harmful information without leaking any other information in accordance with an embodiment of the present disclosure.

FIG. 5 is a schematic representation of steps taken to securely self-verify by interacting with the platforms and generating privacy preserving proofs to notify time-stamp details of all the participant platforms of the verified harmful information to law enforcement subsystem without leaking any other information in accordance with an embodiment of the present disclosure.

FIG. 6 is a schematic representation of steps taken to securely self-verify by interacting with the platforms and generating privacy preserving proofs to notify the stored pseudonymous identity of the originator in relation to the verified harmful information to one of the law enforcement subsystem and judiciary subsystem in accordance with an embodiment of the present disclosure.

FIG. 7 is a schematic representation of steps taken to securely self-verify by interacting with the platforms and generating privacy preserving proofs to notify the stored personally identifiable information in relation to the verified harmful information to one of the law enforcement subsystem and the judiciary subsystem in accordance with an embodiment of the present disclosure.

FIG. 8 is a schematic representation of the workflow of the privacy compliant unified social media platform ecosystem integrating stakeholders at an individual platform level in accordance with an embodiment of the present disclosure:

FIG. 9 (a) is a schematic representation of the application of commitment scheme in the privacy compliant unified social media platform ecosystem integrating stakeholders in accordance with an embodiment of the present disclosure.

FIG. 9 (b) is a schematic representation of designing a Secure Multi Party Compute interaction system integrating different stakeholders in the ecosystem achieving the result of same level of privacy and security in the real world as it would have been in an ideal world with a central trusted party.

FIG. 10 is a block diagram of a computer or a server in accordance with an embodiment of the present disclosure.

FIG. 11 is a flowchart representing the steps of a method 180 of operating unified social media ecosystem with self-verification and privacy preserving proofs in accordance with an embodiment of the present disclosure.

FIG. 12 provides a summary of Unified Social Media Ecosystem, where participants and stakeholders interact with single platform initially using secure self-verification and generating privacy preserving proofs.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a” “an”, and “the” include plural references unless the context clearly dictates otherwise.

Embodiments of the present disclosure relate to a privacy compliant unified Social media platform ecosystem integrating stakeholders enabling them with secure self-verification and privacy preserving proofs in a geography. The system includes a user identity mapping subsystem. The user identity mapping subsystem is configured in a computing system operable by a processor and configured to store a personally identifiable information and a pseudonymous identity associated with registered users upon registration in a corresponding social media platform.

The system also includes a pseudonymous identity and shared information subsystem. The pseudonymous identity and shared information subsystem is configured in the computing system operable by the processor and operatively coupled to the user identity mapping subsystem. The pseudonymous identity and shared information subsystem is configured to capture pseudonymous cryptographic commitments, where some of the attributes may be a pseudonymous identity of an originator of an information in the social media platform, a pseudonymous identity of each information upon sharing the information on the social media platform, time stamp of information sharing and information of the external platform if it is an external share which may be managed centrally or distributed.

The system also includes a harmful content reporting subsystem. The harmful content reporting subsystem is configured in the computing system operable by the processor and operatively coupled to the pseudonymous identity and shared information subsystem. The harmful content reporting subsystem is configured to record reported harmful information by a known or anonymous user without knowing information about the pseudonymous identity of the originator of information. The system also includes a reported harmful content verification subsystem. The reported harmful content verification subsystem is configured in the computing system operable by the processor and operatively coupled to the harmful content reporting subsystem. The reported harmful content verification subsystem is configured to receive verification associated with a reported harmful information from one or multiple entities without knowledge of originator or reporter.

The system also includes a unified social media platforms exchange subsystem. The unified social media platforms exchange subsystem is operable by the processor and configured to identify the social media platforms containing the verified harmful information based on the captured pseudonymous identity of the verified harmful information without leaking any other information. The unified social media platforms exchange subsystem is also configured to delete the verified harmful information across corresponding identified Social media platform without leaking any other information. The unified social media platforms exchange subsystem is also configured to delete the verified harmful information across social media ecosystem so as to prevent spreading of the verified harmful information without leaking any other information.

The unified social media platforms exchange subsystem helps in exchanging privacy preserving proofs as a secure self-service across the platform. The subsystem can be centralized as in the case of cloud service or decentralized as in the case of usage by end devices held by individual stakeholders. The subsystem may also be designed in such a way that the during the secure self-verification and information retrieval using privacy preserving proofs, the sender transfers appropriate information to the receiver even without himself seeing it.

The unified social media platforms exchange subsystem is also configured to notify time-stamp details of all the participant platforms of the verified harmful information to law enforcement subsystem without leaking any other information. The unified social media platforms exchange subsystem is also configured to identify or notify the pseudonymous identity of the originator of harmful content across platforms and subsequently identify the personally identifiable information of the originator in relation to the verified harmful information and securely disclose it to authorized entity only after receiving digital verification proofs from all necessary entities, without leaking of any other information to any other entity.

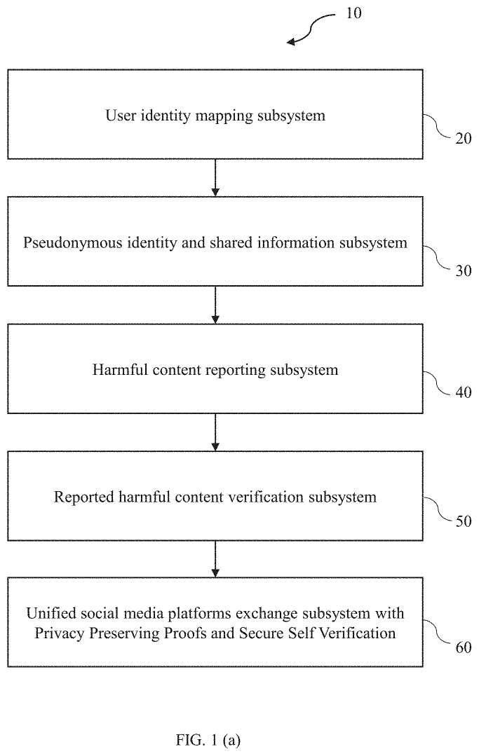

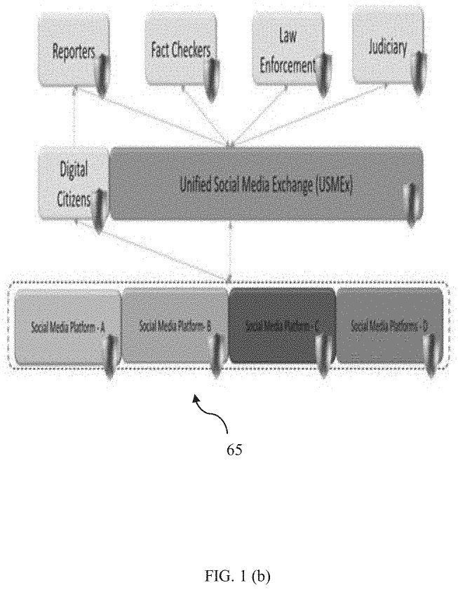

FIG. 1 (a) is a block diagram representation of a privacy compliant unified social media platform ecosystem with privacy preserving proofs and secure self-verification 10 integrating stakeholders in a geography in accordance with an embodiment of the present disclosure. The system 10 basically provides an interaction facility between different stakeholders of a geographical area such as social media boards, legal authorities and law enforcement officials. In one embodiment, the interaction is facilitated without leaking any extra information.

Basically, the system 10 enables creation of privacy preserving proofs and secure self-verification resulting in easy identification of social media platforms containing the harmful information, easy identification of the platform of primary harmful content origin, easy deletion the verified harmful information across corresponding identified social media platform, easy deletion of the verified harmful information across social media ecosystem, easy notification of time-stamp details of all the participant platforms and lastly identification of the pseudonymous identity of the originator of harmful content across platforms and subsequently identification of the personal identifiable information of the originator.

As used herein, information is associated with data and knowledge, as data is meaningful information and represents the values attributed to parameters. Further knowledge signifies understanding of an abstract or concrete concept.

The system 10 includes a user identity mapping subsystem 20. The user identity mapping subsystem 20 is configured in a computing system operable by a processor. The user identity mapping subsystem 20 is configured to store one or multiple sets of personally identifiable information and a pseudonymous identity associated with registered users upon registration in a corresponding social media platform.

In one embodiment, the social media platform may include an end-to-end encrypted messaging platform, online social media platform, online social networking platform and an internet-based software platform for creating and sharing the information across a plurality of information sharing system in multiple countries or just for a specific country.

The system 10 also includes a pseudonymous identity and shared information subsystem 30. The pseudonymous identity and shared information subsystem 30 is configured in the computing system operable by the processor and operatively coupled to the user identity mapping subsystem 20. The pseudonymous identity and shared information subsystem 30 is configured to capture pseudonymous cryptographic commitments, where some of the attributes may be a pseudonymous identity of an originator of an information in the social media platform, a pseudonymous identity of each information upon sharing the information on the social media platform, time stamp of information sharing and information of the external platform if it is an external share which may be managed centrally or distributed. As used herein, the term “timestamp” is the current time of an event that is recorded by a computer.

In one embodiment, the pseudonymous identity of shared information may include a cryptographic representation of the information, wherein the cryptographic representation of information may include one of a hash of the information which is a natural fingerprint of the information, or any one way trap door function or a pseudo-random number artificially attached to the information and traverses with the information across an ecosystem.

In one specific embodiment, the pseudonymous identity and shared information subsystem 30 may be configured to capture pseudonymous identity of the content and the pseudonymous identity of the user every time its shared or only when new and unique information which is validated through cryptographic hash value for identifying the origin of information based on the requirement. In case of restricted data access, there may be a global anonymized list of unique messages sent on the platform. This anonymized list may be populated by user's pseudonymous identity and shared information after anonymization. The access to such anonymized list may be provided just to legally authorized entities only and context of access may be verified by an entity, say by oversight board, in a privacy preserving way. This may be a confirmatory database to validate uniqueness of the shared information, wherein the database can be centralized, distributed, with platform or the user.

The system 10 also includes a harmful content reporting subsystem 40. The harmful content reporting subsystem 40 is configured in the computing system operable by the processor and operatively coupled to the pseudonymous identity and shared information subsystem 30. The harmful content reporting subsystem 40 is configured to record reported harmful information by a known or anonymous user without knowing information about the pseudonymous identity of the originator of information.

In one embodiment, the harmful information may include intent and knowledge. In such embodiment, the intent may include misinformation, disinformation, criminal content or any other blacklisted content. Further, the misinformation may include urban legends. The disinformation may include fake news. The knowledge may include opinion-based knowledge and fact-based knowledge. The opinion-based knowledge may include fake reviews. The fact-based knowledge may include hoaxes. The criminal content may belong to categories like child abuse, obscene content, women harassment, online frauds, hate speech, violence, true threats, defamation, content relating to national security, piracy and other illegal content as per law of the land.

The system 10 also includes a reported harmful content verification subsystem 50. The reported harmful content verification subsystem 50 is configured in the computing system operable by the processor and operatively coupled to the harmful content reporting subsystem 40. The reported harmful content verification subsystem 50 is configured to receive verification associated with a reported harmful information from one or multiple authorized entities without knowledge of originator or reporter.

In one embodiment, the reported harmful content verification subsystem 50 may be configured to verify the claim associated with the reported harmful information from one or more authorized users. In such embodiment, the one or more authorized users may include a plurality of government agencies such as a police, a health care, a cyber security and the like. Such verification entities may be defined by law or put in place by the service provider as part of the terms of service of the platform. The system may allow pluggability of AI based systems and Manual systems for reported content verification.

The system 10 also includes a unified social media platforms exchange subsystem 60. The unified Social media platforms exchange subsystem 60 is operable by the processor and operatively coupled to the reported harmful content verification subsystem 50. For prevention of spread of harmful information and identification of originator of harmful content across information sharing ecosystem, the unified Social media platforms exchange subsystem 60 is designed with privacy preserving technologies like Zero Knowledge Proof system, Secure Multi Party Compute, Cryptographic Commitment Schemes, Verifiable Claims. Oblivious transfer. Secure enclaves, trusted execution environment (TEE), pseudonymous identity, decentralized identity and secure communications for online platforms. The Unified Social media platforms Exchange subsystem helps in creation, exchange and verification of Privacy Preserving Proofs using Secure Self verification by stake holders. Unified Social Media Exchange uses a novel combination of above-mentioned technologies and enables interaction of multiple stakeholders as shown in FIG. 1(b).

As used herein, the “zero-knowledge proof technique” is a specification of how a prover and verifier can interact for the prover to convince the verifier that the statement is true. The proof system must be complete, sound and zero-knowledge. Complete: If the statement is true and both prover and verifier follow the protocol; the verifier will accept. Sound: If the statement is false, and the verifier follows the protocol; the verifier will not be convinced. Zero-knowledge: If the statement is true and the prover follows the protocol: the verifier will not learn any confidential information from the interaction with the prover but the fact the statement is true.

“Zero-knowledge” proofs allow one party (the prover) to prove to another (the verifier) that a statement is true, without revealing any information beyond the validity of the statement itself. For example, given the hash of a random number, the prover could convince the verifier that there indeed exists a number with this hash value, without revealing what it is. In a zero-knowledge “Proof of Knowledge” the prover can convince the verifier not only that the number exists, but that they in fact know such a number—again, without revealing any information about the number.

The acronym zk-SNARK stands for “Zero-Knowledge Succinct Non-Interactive Argument of Knowledge,” where “Succinct” zero-knowledge proofs may be verified within a few milliseconds, with a proof length of only a few hundred bytes even for statements about programs that are very large. In the first zero-knowledge protocols, the prover and verifier had to communicate back and forth for multiple rounds, but in “non-interactive” constructions, the proof consists of a single message sent from prover to verifier. Currently, the most efficient known way to produce zero-knowledge proofs that are non-interactive and short enough to publish to a block chain is to have an initial setup phase that generates a common reference string shared between prover and verifier. The common reference string as the public parameters of the system.

In one embodiment, Secure Multi Party Compute protocol aims to ensure are:

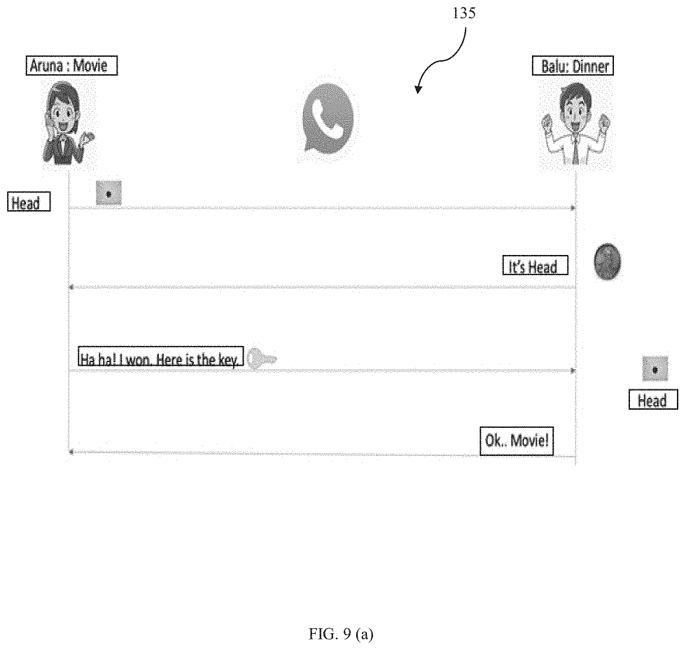

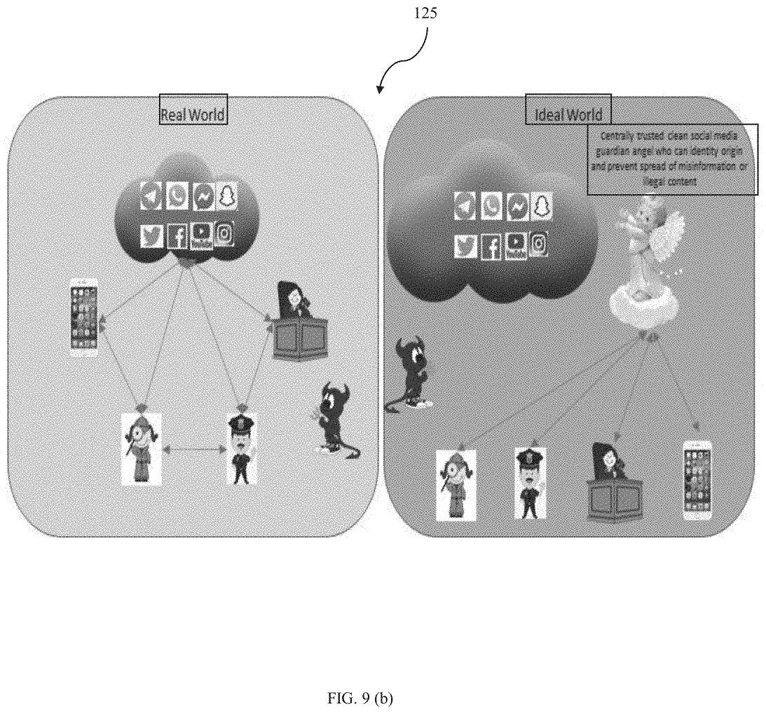

Input privacy: No information about the private data held by the parties can be inferred from the messages sent during the execution of the protocol. The only information that may be inferred about the private data is whatever could be inferred from seeing the output of the function alone.
Correctness: Any proper subset of adversarial colluding parties willing to share information or deviate from the instructions during the protocol execution should not be able to force honest parties to output an incorrect result. (as shown in FIG. 9 (b))

As shown in FIG. 1c, in a Secure MPC protocol, the Real World/Ideal World Paradigm states two worlds: (i) In the ideal-world model, there exists an incorruptible trusted party to whom each protocol participant sends its input. This trusted party computes the function on its own and sends back the appropriate output to each party. (ii) In contrast, in the real-world model, there is no trusted party and all the parties can do is to exchange messages with each other. A protocol is said to be secure if one can learn no more about each party's private inputs in the real world than one could learn in the ideal world. In the ideal world, no messages are exchanged between parties, so real-world exchanged messages cannot reveal any secret information.

The Real World/Ideal World Paradigm provides a simple abstraction of the complexities of MPC to allow the construction of an application under the pretense that the MPC protocol at its core is actually an ideal execution. If the application is secure in the ideal case, then it is also secure when a real protocol is run instead.

As used herein, “Cryptographic Commitment Schemes” is a cryptographic technique that allows one to commit to a chosen value (or chosen statement) while keeping it hidden to others, with the ability to reveal the committed value later. Commitment schemes are designed so that a party cannot change the value or statement after they have committed to it: that is, commitment schemes are binding. Commitment schemes have important applications in a number of cryptographic protocols including secure coin flipping, zero-knowledge proofs, and secure computation.

A way to visualize a commitment scheme is to think of a sender as putting a message in a locked box and giving the box to a receiver. The message in the box is hidden from the receiver, who cannot open the lock themselves. Since the receiver has the box, the message inside cannot be changed-merely revealed if the sender chooses to give them the key at some later time.

Interactions in a commitment scheme take place in two phases:
1. the commit phase during which a value is chosen and specified
2. the reveal phase during which the value is revealed and checked

In simple protocols, the commit phase consists of a single message from the sender to the receiver. This message is called the commitment. It is essential that the specific value chosen cannot be known by the receiver at that time (this is called the hiding property.) A simple reveal phase would consist of a single message, the opening, from the sender to the receiver, followed by a check performed by the receiver. The value chosen during the commit phase must be the only one that the sender can compute and that validates during the reveal phase (this is called the binding property.)

As used herein, the term “Verifiable Claims” may represent all of the same information that a physical credential represents. The addition of technologies, such as digital signatures, makes verifiable credentials more tamper-evident and more trustworthy than their physical counterparts. Holders of verifiable credentials can generate verifiable presentations and then share these verifiable presentations with verifiers to prove they possess verifiable credentials with certain characteristics. Both verifiable credentials and verifiable presentations may be transmitted rapidly, making them more convenient than their physical counterparts when trying to establish trust at a distance.

As used herein, the term “oblivious transfer (OT)” is a type of protocol in which a sender transfers one of potentially many pieces of information to a receiver, but remains oblivious as to what piece if any has been transferred. As used herein, the term “trusted execution environment (TEE)” is a secure area of a main processor. Trusted execution environment (TEE) guarantees code and data loaded inside to be protected with respect to confidentiality and integrity. A TEE as an isolated execution environment provides security features such as isolated execution, integrity of applications executing with the TEE, along with confidentiality of their assets. In general terms, the TEE offers an execution space that provides a higher level of security for trusted applications than a rich operating system (OS) and more functionality than a ‘secure element’ (SE).

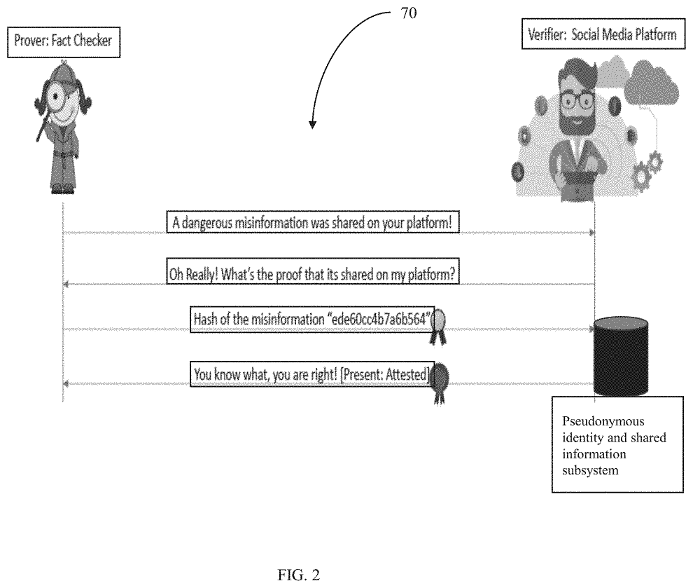

The unified Social media platforms exchange subsystem 60 is configured to identify the social media platforms containing the verified harmful information based on the captured pseudonymous identity of the verified harmful information without leaking any other information. FIG. 2 is a schematic representation of steps taken to securely self-verify by interacting with the platforms and generating privacy preserving proofs to identify the social media platforms 70 containing the verified harmful information in accordance with an embodiment of the present disclosure. This may be the platform on which the content was reported as being circulating to a regulating body.

In order to identify the social media platforms circulating the verified harmful information, the unified social media platforms exchange subsystem 60 is configured to produce “Privacy Preserving Proof of Sharing of Content” on a platform. For identification of the social media platforms, the unified social media platforms exchange subsystem 60 is designed to receive the pseudonymous identity of the verified harmful information from harmful content verification subsystem 50. Privacy preserving proof of sharing of content can be a secure self-verification proof issued to authorized authority or user or reporter by the platform's subsystem in a trustworthy way.

Furthermore, the unified social media platforms exchange subsystem 60 is also designed to request the social media platform to confirm presence of the verified harmful information by comparing the pseudonymous identity of the verified harmful information with the pseudonymous identities of all the information shared by the social media platform.

Subsequently, the social media platform adds the verified harmful information in a blacklisted harmful information database. In another embodiment, without any leak of other information shared on the platform, every verifier may check for themselves in a trustworthy way if a given certified harmful content has been shared on a platform, along with generating a verifiable digital proof for circulation of the content on a platform or multiple platforms. When an authorized entity is requesting for secure self-verification of a sharing and circulation of a harmful content in a social media platform, the entity is allowed to self-verify the sharing of content on the platform in a privacy compliant way. Post verification and if a Pseudonymous content match is found, the entity is provided a “Privacy Preserving Proof of Sharing of Content”. This can be achieved without the involvement of the platform or any of its entities in a trustworthy way.

For example, during reporting of any illegal content, the system 10 enable verification of posting of reported content on platform irrespective of deletion. At first, any external party like any regulator may authorize reporting of the illegal content. The external party in turn may require secure verifiable proof of reporting and acceptance from the social media platform. The platform may in turn receives the pseudonymous identity of the illegal content information from the external party.

The platform and the external party, say regulator or reporter, both get a verifiable and trustworthy proof of reporting of a posted potentially harmful content at a given point of time. Such verifiable proof enable regulator and the social media platform to accept a reported illegal content on a platform. Furthermore, the system enables zero leak of knowledge to external parties even during verification about contents, likes and forwards at this stage, with just secure digital proofs helping automate future process. It is pertinent to note that after identification, the system shares the blacklisted harmful information database with a law enforcement subsystem.

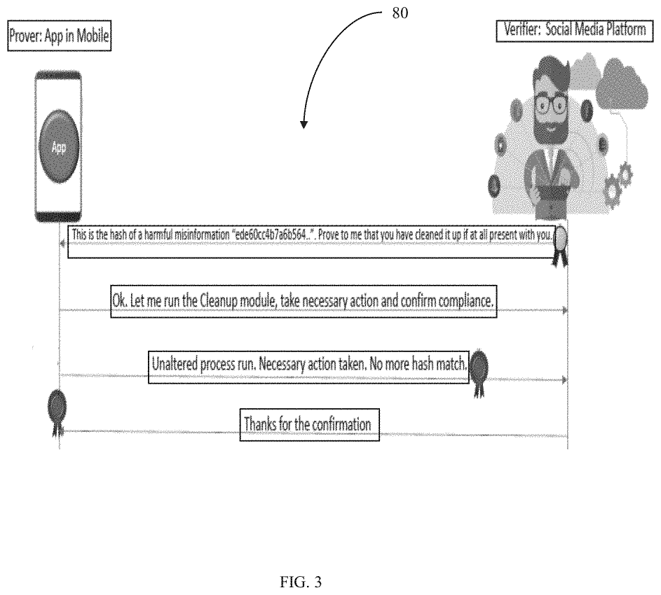

The unified social media platforms exchange subsystem 60 is configured to delete the verified harmful information across corresponding identified Social media platform without leaking any other information. FIG. 3 is a schematic representation of steps taken to securely self-verify by interacting with the platforms and generating privacy preserving proofs to delete the verified harmful information across corresponding identified social media platform 80 without leaking any other in accordance with an embodiment of the present disclosure.

In order to delete the verified harmful information across a corresponding reported social media platforms, the unified social media platforms exchange subsystem is configured to produce “Privacy Preserving Proof of action on harmful content” for the platforms which it may share with verifiers. For deletion, the unified Social media platforms exchange subsystem is designed to instruct the corresponding identified Social media platforms to delete the verified harmful information from the identified Social media platforms. Privacy Preserving Proof of action on harmful content can be a secure self-verification proof issued to authorized authority or user or reporter or platform by the subsystem in a trustworthy way.

In such embodiment, after instruction the reported social media platform is configured to detect the verified harmful information in the identified social media platform by comparing the pseudonymous identity of the verified harmful information with the pseudonymous identities of all the information shared. Furthermore, the identified Social media platform is also configured to delete the verified harmful information, after matching of pseudonymous identity of the verified harmful information, in a plurality of smart devices distributed or servers centralized systems. Simultaneously, the identified Social media platform provide a proof of “Good Samaritan Blocking” actions taken by platform removing malicious content using artificial intelligence. Even those voluntary deletion of harmful content can be certified with “Privacy Preserving Proof of action on harmful content”. This can be used by platforms as secure verifiable proofs for issuing community reports and for external audits to regulators.

In one embodiment, such deletion step encompasses zero leak of knowledge to external parties even during verification about contents, likes and forwards at this stage, with just secure digital proofs helping automate future process. Thereby meeting Criminal law and Privacy law compliance and also protecting innocent user from profitability and likability due to information leak. The system provides an auditable, immutable, verifiable, reusable and zero information leak secure digital proof for external verification.

Here, the plurality of smart devices (distributed) or servers (centralized systems) being configured to receive pseudonymous identity of the verified harmful information, locally take the action required and notify the identified Social media platform after taking the recommended action against verified harmful information. In such embodiment, smart devices (distributed) or servers (centralized systems) deleting the verified harmful content in a privacy compliant way that the platform on receiving the digitally secure privacy proofs does not learn who had the content and who did not, but just knows that the devices are now compliant. In such embodiment, regulatory verification and issuance of compliance proof on a specific notice-and-action for the platform by the regulator.

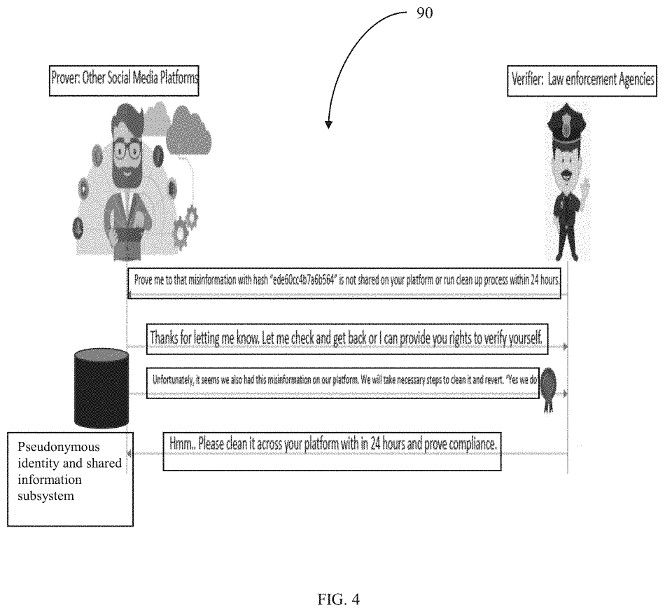

The unified Social media platforms exchange subsystem 60 is configured to delete the verified harmful information across social media ecosystem so as to prevent spreading of the verified harmful information without leaking any other information. FIG. 4 is a schematic representation of steps 90 taken to securely self-verify by interacting with the platforms and generating privacy preserving proofs to delete the verified harmful information across social media ecosystem so as to prevent spreading of the verified harmful information without leaking any other information in accordance with an embodiment of the present disclosure.

In order to delete the verified harmful information across social media ecosystem so as to prevent spreading of the verified harmful information, for flagging harmful content and cleaning of all social media platforms of the verified harmful content, the unified social media platforms exchange subsystem is configured to produce “Privacy Preserving Time bound compliance proof” for platforms. For deletion, the unified Social media platforms exchange subsystem is designed to share the harmful information to the law enforcement subsystem. Privacy Preserving Time bound compliance proof can also be used in all scenarios where action taken by platform is mandated and has a time limit to be complied with. Privacy Preserving Time bound compliance proof can be a secure self-verification proof issued to the platform by the subsystem in a trustworthy way.

In such embodiment, after sharing the law enforcement subsystem is configured to request the social media ecosystem to identify the verified harmful information stored in the blacklisted harmful information database within the social media ecosystem.

The law enforcement subsystem is configured to instruct the social media ecosystem to delete or flag or take other action on the verified harmful information identified from the social media ecosystem within a predefined duration. In such embodiment, social media platform getting digital privacy preserving proofs from its content handling software either at the client devices or at the server of execution of recommended action against harmful content, which may be shared with the verifier.

Such above mentioned steps allow law enforcement agencies to verify received reports of criminal content across multiple social media platforms for single instance or multiple instance of posting within any platform. Here, automated verification, digital proofs and trigger notice-and-action are time bound. It is pertinent to note that there is no leak of any profilable or linkable user information in this verification process. Thereby, enabling platform to prove highest levels of criminal and privacy law compliance.

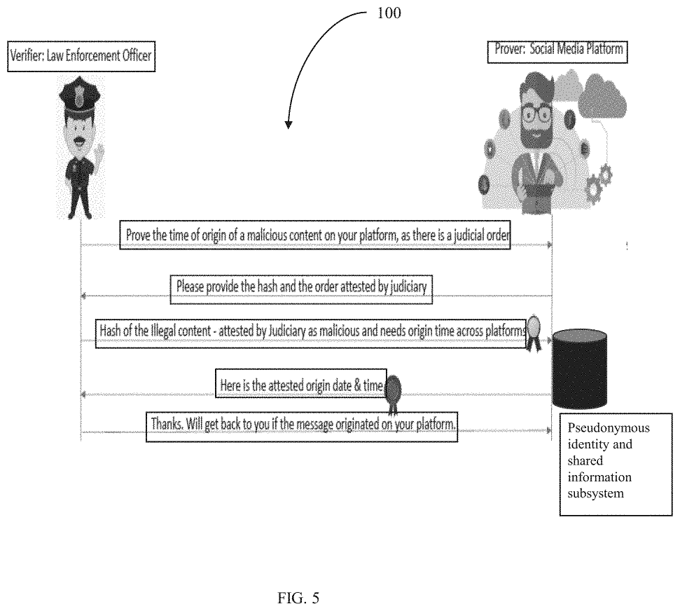

The unified social media platforms exchange subsystem 60 is configured to notify time-stamp details of all the participant platforms of the verified harmful information to law enforcement subsystem without leaking any other information. FIG. 5 is a schematic representation of steps 100 taken to securely self-verify by interacting with the platforms and generating privacy preserving proofs to notify time-stamp details of all the participant platforms of the verified harmful information to law enforcement subsystem without leaking any other information in accordance with an embodiment of the present disclosure.

In order to notify time-stamp details of the verified harmful information to the legally authorized entity, the unified Social media platforms exchange subsystem is configured to produce “Privacy Preserving Proof of initial origination platform and time” across platforms. For notifying, the unified Social media platforms exchange subsystem is designed to share the blacklisted harmful information database to the law enforcement subsystem. Privacy Preserving Proof of initial origination platform and time can be a secure self-verification proof issued to the platform and the regulator by the subsystem in a trustworthy way.

In such embodiment, the law enforcement subsystem is configured to request the identified social media platforms to identify the time-stamp details of the verified harmful information. The law enforcement subsystem is also configured to instruct the identified Social media platform to share identified time-stamp details of the verified harmful information.

The law enforcement subsystem is also configured to identify the platform of initial harmful information origin, by comparing the origin time across all the proofs submitted by the platforms and generate “Privacy Preserving Proof of initial origination platform and time”.

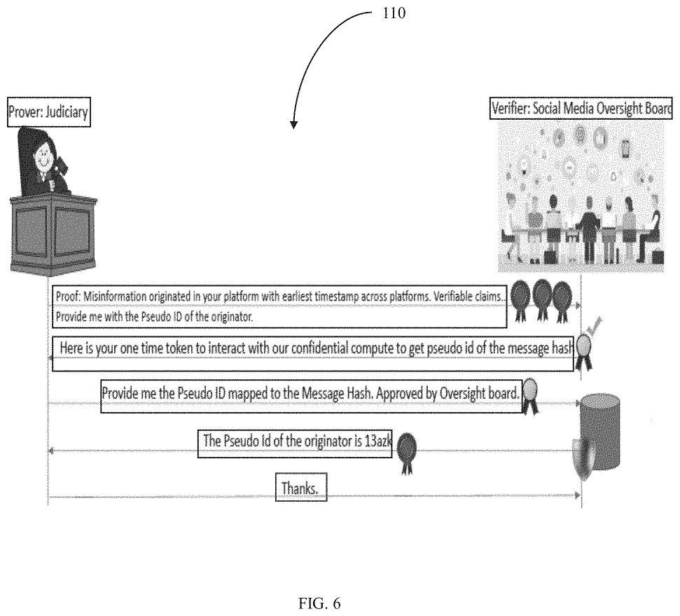

The unified social media platforms exchange subsystem 60 is configured to notify the stored pseudonymous identity of the originator in relation to the verified harmful information to one of the law enforcement subsystem and judiciary subsystem. FIG. 6 is a schematic representation of steps 110 taken to securely self-verify by interacting with the platforms and generating privacy preserving proofs to notify the stored pseudonymous identity of the originator in relation to the verified harmful information to one of the law enforcement subsystem and judiciary subsystem in accordance with an embodiment of the present disclosure.

In order to identify and transfer the stored pseudonymous identity of the originator in relation to the verified harmful information to one of the law enforcement subsystem and judiciary subsystem, the unified Social media platforms exchange subsystem is configured to produce “Secure Proof of Pseudonymous Identity of Originator”. For notification, the unified Social media platforms exchange subsystem is designed to prove to the identified originating Social media platform that it is the originator of the verified harmful information using “Privacy Preserving Proof of initial origination platform and time”.

The unified social media platforms exchange subsystem is also designed to request the identified originating Social media platform to share identified pseudonymous identity of the originator to the authorized subsystem after validating privacy preserving proofs from relevant subsystems.

The unified social media platforms exchange subsystem is also designed to share the pseudonymous identity of the originator of the harmful content by the Social media platform's authorized subsystem to the law enforcement subsystem and the judiciary subsystem as a Secure Proof of Pseudonymous Identity of Originator, which may be a regular or an oblivious transfer.

In one embodiment, during oblivious transfer, the identified Social media platform via social media oversight board may provide details regarding the pseudonymous identity of the originator. In such embodiment, the law enforcement subsystem and the judiciary subsystem are basically provided with originator identity but the social media oversight board and the Social media platform is unaware of the originator identity.

The Oversight board may need to approve transfer of the pseudonymous identity of a harmful content to judiciary to understand if the content is really malicious, but post approval it would not know what was the pseudo ID which was actually received by the platform. In a way, the Oversight board may have privilege only to write into the system but not read it at later point. Such transaction may also be tightly access controlled so that one authorized parties after proving all mandatary requirements can trigger the information transfer or oblivious transfer.

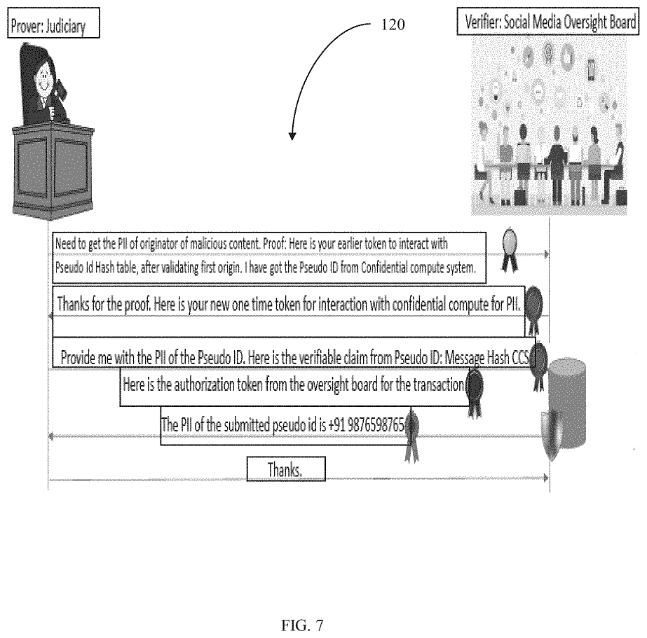

The unified social media platforms exchange subsystem 60 is configured to notify the stored personally identifiable information in relation to the verified harmful information to one of the law enforcement subsystem and the judiciary subsystem. FIG. 7 is a schematic representation of steps 120 taken to securely self-verify by interacting with the platforms and generating privacy preserving proofs to notify the stored personally identifiable information in relation to the verified harmful information to one of the law enforcement subsystem and the judiciary subsystem in accordance with an embodiment of the present disclosure.

In order to notify the stored personally identifiable information in relation to the verified harmful information to one of the law enforcement subsystem and the judiciary subsystem, the unified social media platforms exchange subsystem is configured to produce “Secure proof of Pseudonymous Identity of originator”. For notification, the unified social media platforms exchange subsystem is designed to prove to the identified originating social media platform using ‘Privacy Preserving Proof of initial origination platform and time’ and ‘Secure Proof of Pseudonymous Identity of Originator’. Secure proof of Pseudonymous Identity of originator can be a secure self-verification proof issued to the authorized authority by the subsystem.

The unified social media platforms exchange subsystem is also designed to instruct the identified social media platform to share identified personally identifiable information to the law enforcement subsystem and the judiciary subsystem. In such embodiment, the identified Social media platform validates the produced proofs, approval from oversight board and on confirmation shares the “Secure proof of Pseudonymous Identity of originator”, which may be a regular or an oblivious transfer. Secure proof of Personally Identifiable Information of originator can be a secure self-verification proof issued to the regulator by the subsystem in a trustworthy way.

In one embodiment, during oblivious transfer, the identified social media platform via social media oversight board may provide details regarding the personally identifiable information of the originator. In such embodiment, the law enforcement subsystem and the judiciary subsystem is basically provided with personally identifiable information but the social media oversight board and the Social media platform is unaware of the originator identity. Such transaction may also be tightly access controlled so that one authorized parties after proving all mandatary requirements can trigger the information transfer or oblivious transfer.

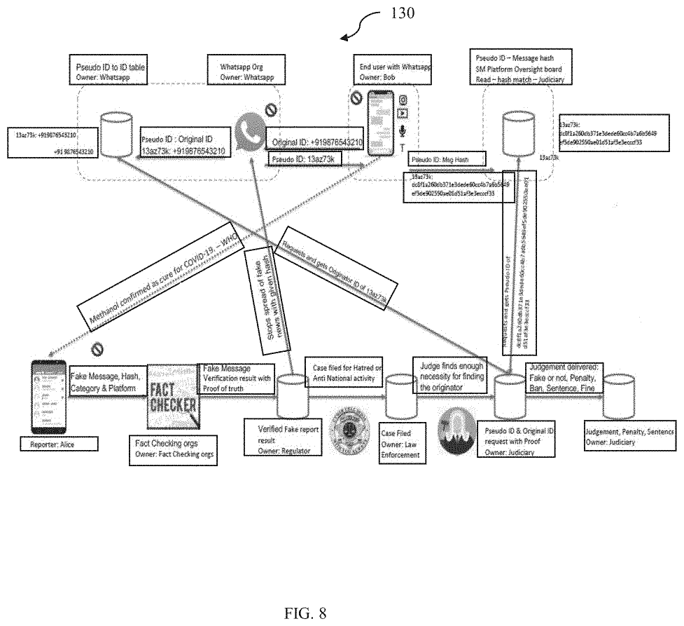

FIG. 8 is a schematic representation of the workflow 130 of the privacy compliant unified social media platform ecosystem integrating stakeholders at an individual platform level in accordance with an embodiment of the present disclosure. In one exemplary embodiment, the workflow takes example of a WhatsApp message platform. Specific originator of a harmful information forwards the message to BOB, who in turn forwards the message to Alice. Alice reports the message to a fact checker or law enforcement agency for checking the fact of the forwarded message. In such embodiment, the forwarded message may be that “Methanol confirmed as cure for COVID-19—WHO” or may be a morphed picture of a women used for blackmailing or harassment.

As the forwarded message is verified as harmful information, the system starts via a unified Social media platforms exchange subsystem 60 starts the required legal process associated with stakeholders in a specific geography. Till verification of harmful information step, the system uses user an identity mapping subsystem 20, a pseudonymous identity and shared information subsystem 30, a harmful content reporting subsystem 40 and a reported harmful content verification subsystem 50, as shown in FIG. 1 a

The unified social media platforms exchange subsystem 60 enables easy identification of social media platforms containing the harmful information, easy identification of the platform of primary harmful content origin, easy deletion the verified harmful information across corresponding identified Social media platform, easy deletion the verified harmful information across social media ecosystem, easy notification of time-stamp details of all the participant platforms and lastly identification of the pseudonymous identity of the originator of harmful content across platforms and subsequently identification of the personal identifiable information of the originator.

In given exemplary embodiment, a judge may be able to get the platform of primary harmful content origin and the personal identifiable information of the originator with the help of a social media platform oversight board. The social media platform oversight board may be able to store the pseudonymous details of information as well as pseudonymous details of the originator via a commitment scheme. Such commitment scheme may be referred back to cross-check in real time. Such process also enables zero leak of knowledge. The notifying process of information is all together is General Data Protection Regulation GDPR compliant.

FIG. 9 a is a schematic representation of the application of commitment scheme in the privacy compliant unified Social media platform ecosystem 135 integrating stakeholders in a geography in accordance with an embodiment of the present disclosure. In simple protocols, the commit phase consists of a single message from the Aruna sender to the Balu receiver. This message is called the commitment. It is essential that the specific value chosen may not be known by the receiver at that time this is called the hiding property. For example, before toss Aruna conveys in pseudonymous note to Balu, that she chooses “head”. Balu may not open the pseudonymous note till the toss is complete.

A simple reveal phase would consist of a single message, the opening, from the sender Aruna to the receiver Balu, followed by a check performed by the receiver Balu. The value chosen during the commit phase must be the only one that the sender may compute and that validates during the reveal phase this is called the binding property. The Commitment scheme needs to have hiding and binding property and can use hashing, encryption or any one way trap door function.

The identity mapping subsystem 20, the pseudonymous identity and shared information subsystem 30, the harmful content reporting subsystem 40, the reported harmful content verification subsystem 50 and the unified social media platforms exchange subsystem 60 in FIG. 8 is substantially equivalent to the identity mapping subsystem 20, the pseudonymous identity and shared information subsystem 30, the harmful content reporting subsystem 40, the reported harmful content verification subsystem 50 and the unified social media platforms exchange subsystem 60 of FIG. 1.

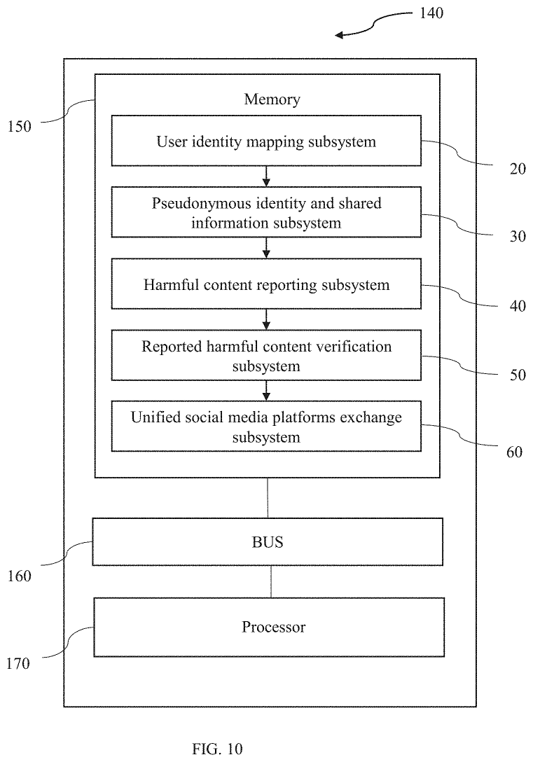

FIG. 10 is a block diagram of a computer or a server 140 in accordance with an embodiment of the present disclosure. The server 140 includes processors 170, and memory 150 coupled to the processors 170.

The processors 170, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 150 includes a plurality of modules stored in the form of executable program which instructs the processor 170 via a bus 160 to perform the method steps illustrated in FIG. 1. The memory 150 has following modules, the identity mapping subsystem 20, the pseudonymous identity and shared information subsystem 30, the harmful content reporting subsystem 40, the reported harmful content verification subsystem 50 and the unified social media platforms exchange subsystem 60.

The user identity mapping subsystem 20 is configured in a computing system operable by a processor and configured to store a personally identifiable information and a pseudonymous identity associated with registered users upon registration in a corresponding Social media platform. The pseudonymous identity and shared information subsystem 30 is configured to capture pseudonymous cryptographic commitments, where some of the attributes may be a pseudonymous identity of an originator of an information in the social media platform, a pseudonymous identity of each information upon sharing the information on the Social media platform, time stamp of information sharing and information of the external platform if it is an external share along with status of the shared content like active, deleted, hidden, flagged, reported or others as per compliance requirement.

The harmful content reporting subsystem 40 is configured to record reported harmful information by a known or anonymous user without knowing information about the pseudonymous identity of the originator of information. The reported harmful content verification subsystem 50 is configured to receive verification associated with a reported harmful information from one or multiple entities without knowledge of originator or reporter.

The unified Social media platforms exchange subsystem 60 is configured to identify the Social media platforms containing the verified harmful information based on the captured pseudonymous identity of the verified harmful information without leaking any other information. The unified social media platforms exchange subsystem 60 is also configured to delete the verified harmful information across corresponding identified social media platform without leaking any other information. The unified social media platforms exchange subsystem 60 is also configured to delete the verified harmful information across social media ecosystem so as to prevent spreading of the verified harmful information without leaking any other information.

The unified social media platforms exchange subsystem 60 is also configured to notify time-stamp details of all the participant platforms of the verified harmful information to law enforcement subsystem without leaking any other information. The unified social media platforms exchange subsystem 60 is also configured to identify the platform of primary harmful content origin in an ecosystem of multiple platforms. The unified social media platforms exchange subsystem 60 is also configured to identify the pseudonymous identity of the originator of harmful content across platforms and subsequently identify the personally identifiable information of the originator in relation to the verified harmful information and securely disclose it to authorized entity only after receiving digital verification proofs from all necessary entities, without leaking of any other information to any other entity.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 170.

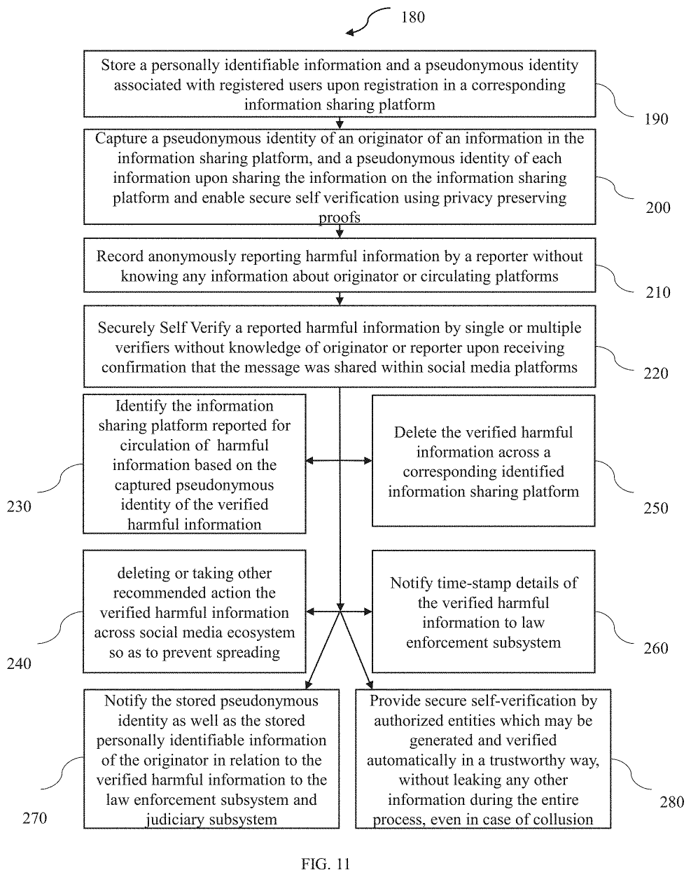

FIG. 11 is a flowchart representing the steps of a method 180 of operating unified social media ecosystem with self-verification and privacy preserving proofs in accordance with an embodiment of the present disclosure. The method 180 includes storing a personally identifiable information and a pseudonymous identity associated with registered users upon registration in a corresponding Social media platform in step 190. In one embodiment, storing the personally identifiable information and the pseudonymous identity associated with registered users upon registration in the corresponding social media platform includes storing the personally identifiable information and the pseudonymous identity associated with registered users upon registration in the corresponding social media platform by a user identity mapping subsystem.

In another embodiment, storing the personally identifiable information and the pseudonymous identity associated with registered users upon registration in the corresponding social media platform includes storing a personally identifiable information and a pseudonymous identity associated corresponding to the Social media platform comprising an end-to-end encrypted messaging platform, social media platform and an internet-based Social media platforms for creating and sharing the information across a plurality of information sharing system in a jurisdiction.

The method 180 also includes capturing a pseudonymous cryptographic commitment, either centrally or distributed method, where some of the attributes may be a pseudonymous identity of an originator of an information in the Social media platform and a pseudonymous identity of each information, time stamp of information sharing, current status of the shared content as per compliance requirement and information of the external platform if it is an external share, upon sharing the information on the Social media platform in step 200. In one embodiment, capturing the pseudonymous identity of the originator of the information in the social media platform and the pseudonymous identity of each information upon sharing the information on the Social media platform includes capturing the pseudonymous identity of the originator of the information in the Social media platform and the pseudonymous identity of each information upon sharing the information on the Social media platform by a pseudonymous identity and shared information subsystem.

The method 180 also includes recording anonymously reporting harmful information by a reporter without knowing any information about originator or circulating platforms in step 210. In one embodiment, recording anonymously reporting harmful information by the reporter without knowing any information about originator or circulating platforms includes recording anonymously reporting harmful information by the reporter without knowing any information about originator or circulating platforms by a harmful content reporting subsystem.

The method 180 also includes verifying a reported harmful information by single or multiple authorized verifiers without knowledge of originator or reporter upon receiving confirmation that the message was shared within Social media platforms in step 220. In one embodiment, verifying the reported harmful information by single or multiple verifiers without knowledge of originator or reporter upon receiving confirmation that the message was shared within Social media platforms includes verifying the reported harmful information by single or multiple authorized verifiers without knowledge of originator or reporter upon receiving confirmation that the message was shared within Social media platforms by a harmful content verification subsystem.

The method 180 also includes identifying the social media platform reported for circulation of harmful information based on the captured pseudonymous identity of the verified harmful information in step 230. In one embodiment, identifying the Social media platform reported for circulation of harmful information based on the captured pseudonymous identity of the verified harmful information includes identifying the Social media platform reported for circulation of harmful information based on the captured pseudonymous identity of the verified harmful information by a unified social media platforms exchange subsystem.

Furthermore, in another embodiment, identifying the social media platform of the verified harmful information, resulting in ‘Privacy Preserving Proof of Sharing of Content’ includes receiving the pseudonymous identity of the verified harmful information from the harmful content verification subsystem. In yet another embodiment, identifying the social media platform of the verified harmful information, resulting in ‘Privacy Preserving Proof of Sharing of Content’ includes requesting the social media platform to confirm sharing and circulation of the verified harmful information by comparing the pseudonymous identity of the verified harmful information with the pseudonymous identities of all the information shared by the social media platform.

In one embodiment, identifying the Social media platform of the verified harmful information, resulting in ‘Privacy Preserving Proof of Sharing of Content’ includes adding the verified harmful information in a blacklisted harmful information database. In another embodiment, identifying the Social media platform of the verified harmful information, resulting in ‘Privacy Preserving Proof of Sharing of Content’ includes sharing the blacklisted harmful information database by the law enforcement subsystem.

The method 180 also includes deleting or flagging the verified harmful information across a corresponding identified social media platform in step 250. In one embodiment, deleting or flagging the verified harmful information across a corresponding identified social media platform includes deleting or flagging the verified harmful information across a corresponding identified Social media platform by the unified social media platforms exchange subsystem.

In another embodiment, deleting or flagging the verified harmful information across a corresponding identified social media platforms, resulting in ‘Privacy Preserving Proof of action on harmful content’ includes instructing the corresponding identified Social media platforms to delete or flag the verified harmful information from the identified Social media platform. In yet another embodiment, deleting or flagging the verified harmful information across a corresponding identified Social media platforms, resulting in ‘Privacy Preserving Proof of action on harmful content’ includes detecting the verified harmful information in the identified Social media platform by comparing the pseudonymous identity of the verified harmful information with the pseudonymous identities of all the information shared.

Furthermore, in one embodiment, deleting or flagging the verified harmful information across a corresponding identified Social media platforms, resulting in ‘Privacy Preserving Proof of action on harmful content’ includes deleting or flagging, by the identified Social media platform, the verified harmful information, after matching of pseudonymous identity of the verified harmful information, in a plurality of smart devices distributed or servers centralized systems and proving compliance without revealing any additional information to the platform.

The method 180 also includes deleting or taking other recommended action the verified harmful information across social media ecosystem so as to prevent spreading in step 240. In one embodiment, deleting or taking other recommended action the verified harmful information across social media ecosystem so as to prevent spreading includes deleting or taking other recommended action the verified harmful information across social media ecosystem so as to prevent spreading by the unified social media platforms exchange subsystem.

In another embodiment, deleting or flagging the verified harmful information across social media ecosystem, resulting in ‘Privacy Preserving Time bound compliance proof’ includes sharing the blacklisted harmful information database to the law enforcement subsystem.

In yet another embodiment, deleting or flagging the verified harmful information across social media ecosystem, resulting in ‘Privacy Preserving Time bound compliance proof’ includes requesting the social media ecosystem to identify the verified harmful information stored in the blacklisted harmful information database within the social media ecosystem using its pseudonymous identity and pseudonymous identity of its possible predictable variants. In one embodiment, deleting or flagging the verified harmful information across social media ecosystem, resulting in ‘Privacy Preserving Time bound compliance proof’ includes instructing, by a law enforcement subsystem, the social media ecosystem to delete or flag the verified harmful information identified and its predictable variants from the social media ecosystem within a predefined duration based on categorization of content.

The method 180 also includes notifying time-stamp details of the verified harmful information to law enforcement subsystem in step 260. In one embodiment, notifying time-stamp details of the verified harmful information to law enforcement subsystem includes notifying time-stamp details of the verified harmful information to law enforcement subsystem by the unified social media platforms exchange subsystem.

In another embodiment, notifying the time-stamp details of the verified harmful information to law enforcement subsystem, resulting in ‘Privacy Preserving Proof of initial origination platform and time’ includes sharing the blacklisted harmful information database to the law enforcement subsystem. In yet another embodiment, notifying the time-stamp details of the verified harmful information to law enforcement subsystem, resulting in ‘Privacy Preserving Proof of initial origination platform and time’ includes requesting, by the law enforcement subsystem, the identified Social media platform to identify the first origin time-stamp details of the verified harmful information.

Furthermore, in one embodiment, notifying the time-stamp details of the verified harmful information to law enforcement subsystem, resulting in ‘Privacy Preserving Proof of initial origination platform and time’ includes instructing, by the law enforcement subsystem, the identified Social media platform to share identified first origin time-stamp details of the verified harmful information by each platform. In another embodiment, notifying the time-stamp details of the verified harmful information to law enforcement subsystem includes identifying the platform of initial harmful information origin, by comparing the origin time across all the proofs submitted by the platforms and generate “Privacy Preserving Proof of initial origination platform and time”.

The method 180 also includes notifying the stored pseudonymous identity as well as the stored personally identifiable information of the originator in relation to the verified harmful information to the law enforcement subsystem and judiciary subsystem in step 270. In one embodiment, notifying the stored pseudonymous identity as well as the stored personally identifiable information of the originator in relation to the verified harmful information to the law enforcement subsystem and judiciary subsystem includes notifying the stored pseudonymous identity as well as the stored personally identifiable information of the originator in relation to the verified harmful information to the law enforcement subsystem and judiciary subsystem by the unified social media platforms exchange subsystem.

In another embodiment, notifying the stored pseudonymous identity of the originator to the law enforcement subsystem, resulting in ‘Secure Proof of Pseudonymous Identity of Originator’ includes sharing the blacklisted harmful information database to the law enforcement subsystem and the judiciary subsystem. In yet another embodiment, notifying the stored pseudonymous identity of the originator to the law enforcement subsystem, resulting in ‘Secure Proof of Pseudonymous Identity of Originator’ includes requesting, the law enforcement subsystem and the judiciary subsystem, the identified social media platform to identify the stored pseudonymous identity of the originator in relation to the verified harmful information.

Furthermore, in one embodiment, notifying the stored pseudonymous identity of the originator to the law enforcement subsystem, resulting in ‘Secure Proof of Pseudonymous Identity of Originator’ includes instructing, by the law enforcement subsystem and the judiciary subsystem, the identified first Social media platform to share identified pseudonymous identity of the originator to the law enforcement subsystem and the judiciary subsystem after verifying digital proofs from all necessary parties without leaking any other information.

In another embodiment, notifying the stored personally identifiable information to the law enforcement subsystem and judiciary subsystem, resulting in ‘Secure proof of Pseudonymous Identity of originator’ includes sharing the blacklisted harmful information database to the law enforcement subsystem and the judiciary subsystem. In yet another embodiment, notifying the stored personally identifiable information to the law enforcement subsystem and judiciary subsystem, resulting in ‘Secure proof of Pseudonymous Identity of originator’ includes requesting, by the law enforcement subsystem and the judiciary subsystem, the identified Social media platform to identify the stored personally identifiable information in relation to the verified harmful information and its originator pseudonymous identity.

In one embodiment, notifying the stored personally identifiable information to the law enforcement subsystem and judiciary subsystem, resulting in ‘Secure proof of Pseudonymous Identity of originator’ includes disclosing, by the Social media platform to the law enforcement subsystem and the judiciary subsystem, the identified personally identifiable information to the law enforcement subsystem and the judiciary subsystem after verification of presented privacy preserving proofs either as normal or oblivious transfer.

The method 180 also includes proving enabling Secure self-verification by authorized entities, resulting in generation of Privacy Preserving Proofs, which can be generated and verified automatically in a trustworthy way, without leaking any other information during the entire process, even in case of collusion in step 280.

The method 180 supports Secure self-verification process in each step which can result in Privacy Preserving Proofs or Privacy Preserving Proofs can be used in a Secure Self Verification process. The process is Secure because the contents of the proofs are digitally signed, which may not be forged. It is a self-verification process, as platform, which in certain cases may have a conflict of interest or privacy concerns, need not be involved in generating the privacy preserving proofs or its verification. Since authorized verifiers can interact with automated systems without human intervention or information leak and generate Privacy Preserving proofs and later also verify them, the process is called Secure self-verification.

Secure self-verification process helps authorized entities in autonomously in generating and verifying proofs in the unified social media ecosystem. Privacy Preserving Proof of Sharing of Content can be issued to regulator or reporter during secure self-verification, while checking presence of a verified or a suspected harmful content in a platform. Privacy Preserving Proof of action on harmful content can be issued by the system to the platform on deleting or flagging content based on an internal or an external notice-to-action request. Privacy Preserving Time bound compliance proof can be issued by the system to the platform on completing notice-to-action request on a verified harmful information within a duration mandated by compliance. Privacy Preserving Proof of initial origination platform and time can be issued to the regulator by the system which can then be shared and verified by other platforms in a secure self-verification method. Secure Proof of Pseudonymous Identity of Originator and Secure proof of PI of originator can be issued to Judiciary or other approved authority which may even be oblivious to the platform, but can be checked using Secure Self Verification without disclosing the sensitive user information to anyone else.

Post generation of a Privacy Preserving Proof, it can be Securely self-verified by the receiver using the digital signature of the proof. The proof can also be used to trigger a new Secure self-verification, which may also prove the validity of the proof.

The method 180 includes prevention of spread of harmful information and identification of originator of harmful content across information sharing ecosystem is achieved using methods designed with privacy preserving technologies like Zero Knowledge Proof, Secure Multi Party Compute, Cryptographic Commitment Schemes, Verifiable Claims, Oblivious transfer, Secure enclaves, pseudonymous identity, decentralized identity and secure communications for online platforms, while protecting user privacy, preventing leak on any information to unintended parties even in case of collusion of multiple dishonest parties. The method is agnostic to the type of database, cipher and hashing protocols.

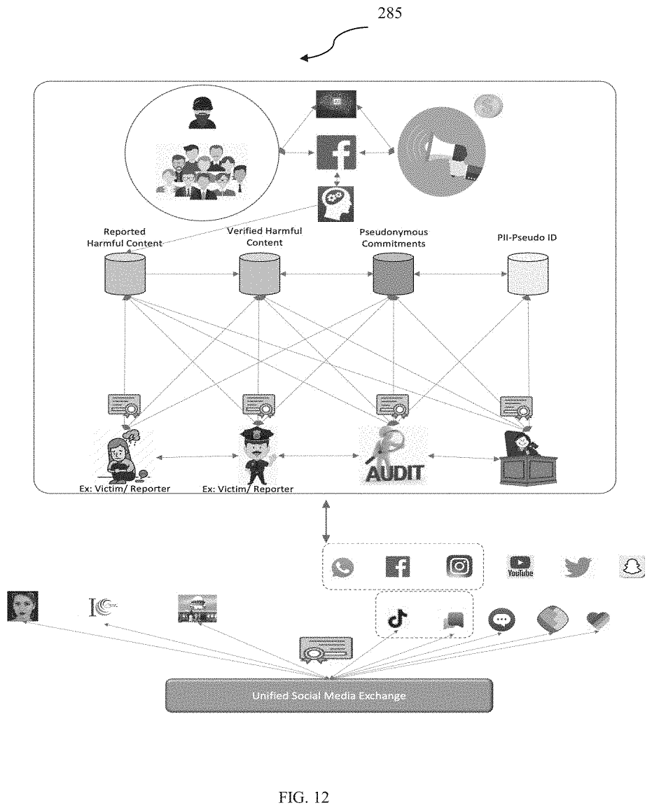

FIG. 12 provides a summary 285 of Unified Social Media Ecosystem, where participants and stakeholders interact with single platform initially using secure self-verification, generating privacy preserving proofs, which can be later exchanged across multiple platforms, resulting in compliance across the ecosystem, which can used for privacy preserving zero knowledge proving of content reporting, establishing compliance to regulators and auditors, notice-and-action, clearing content across ecosystem, identifying the origin platforms, implementing right to access and right to erasure across platforms and ability to identify actual originator across platforms. Thereby, the system 10 basically provides Privacy Preserving Proof of Sharing of Content, Privacy Preserving Proof of action on harmful content, Privacy Preserving Time bound compliance proof, Privacy Preserving Proof of initial origination platform and time, Secure Proof of Pseudonymous Identity of Originator and Secure proof of Personally Identifiable Information of originator

Present disclosure of a privacy compliant unified social media platform provides automatic verification platform for a number of stakeholders in a geography. The system enables easy identification of social media platforms containing the harmful information, easy identification of the platform of primary harmful content origin, easy deletion the verified harmful information across corresponding identified Social media platform, easy deletion the verified harmful information across social media ecosystem, easy notification of time-stamp details of all the participant platforms and lastly identification of the pseudonymous identity of the originator of harmful content across platforms and subsequently identification of the personal identifiable information of the originator.

Added to above stated advantages the system allows zero leak of knowledge to external parties even during verification about contents, likes and forwards at this stage. The system further allows meeting of criminal law and privacy law compliance. Moreover, it further protects innocent user from profitability and likability due to information leak.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A system for unified social media ecosystem with self-verification and Privacy preserving proofs, comprising:
a user identity mapping subsystem, configured in a computing system operable by a processor, and configured to store a personally identifiable information and a pseudonymous identity associated with registered users upon registration in a corresponding social media platform;
a pseudonymous identity and shared information subsystem, configured in the computing system operable by the processor, operatively coupled to the user identity mapping subsystem, and configured to capture pseudonymous cryptographic commitments, where some of the attributes may be a pseudonymous identity of an originator of an information in the Social media platform, a pseudonymous identity of each information upon sharing the information on the social media platform, time stamp of information sharing, current status of the shared content as per compliance requirement and information of the external platform if it is an external share, which may be managed centrally or distributed;
a harmful content reporting subsystem, configured in the computing system operable by the processor, operatively coupled to the pseudonymous identity and shared information subsystem, and configured to record reported harmful information by a known or anonymous user without knowing information about the pseudonymous identity of the originator of information;
a reported harmful content verification subsystem, configured in the computing system operable by the processor, operatively coupled to the harmful content reporting subsystem, and configured to receive verification associated with a reported harmful information from one or multiple entities without knowledge of originator or reporter;
characterized in that
a unified social media platforms exchange subsystem, operable by the processor, configured to:
identify the social media platforms containing the verified harmful information based on the captured pseudonymous identity of the verified harmful information without leaking any other information;
delete the verified harmful information across corresponding identified social media platform without leaking any other information;
delete the verified harmful information across social media ecosystem, after verifying ones in which the harmful content has been circulated, so as to prevent spreading of the verified harmful information without leaking any other information;
notify time-stamp details of all the participant platforms of the verified harmful information to law enforcement subsystem without leaking any other information;
notify the stored pseudonymous identity of the originator in relation to the verified harmful information to one of the law enforcement subsystem and judiciary subsystem;
identify the pseudonymous identity of the originator of harmful content across platforms and subsequently identify the personally identifiable information of the originator in relation to the verified harmful information and securely disclose it to authorized entity only after receiving digital verification proofs from all necessary entities, without leaking of any other information to any other entity; and
enable secure self-verification by authorized entities to verify automatically in a trustworthy way and generate privacy preserving proofs, proving exactly what is needed and without leaking any other information during the entire process, even in case of collusion.

2. The system as claimed in claim 1, wherein in order to identify the social media platforms circulating the verified harmful information, the unified Social media platforms exchange subsystem is configured to produce “Privacy Preserving Proof of Sharing of Content” on a platform, by being designed to:
receive the pseudonymous identity of the verified harmful information from harmful content verification subsystem;
request the social media platform to confirm presence of the verified harmful information by comparing the pseudonymous identity of the verified harmful information with the pseudonymous identities of all the information shared by the social media platform: wherein the Social media platform adds the verified harmful information in a blacklisted harmful information database;
wherein without any leak of other information shared on the platform, every verifier may securely self-verify in a trustworthy way if a given certified harmful content has been shared on a platform, along with generating a verifiable digital proof for circulation of the content on a platform or multiple platforms; and
share the blacklisted harmful information database with a law enforcement subsystem.

3. The system as claimed in claim 1, wherein in order to delete the verified harmful information across a corresponding identified Social media platforms, the unified social media platforms exchange subsystem is configured to produce “Privacy Preserving Proof of action on harmful content” for the platforms which it may share with verifiers, by being designed to:
instruct the corresponding identified social media platforms to delete the verified harmful information from the identified Social media platforms,
wherein the identified Social media platform is configured to:
detect the verified harmful information in the identified Social media platform by comparing the pseudonymous identity of the verified harmful information with the pseudonymous identities of all the information shared;
delete the verified harmful information, after matching of pseudonymous identity of the verified harmful information, in a plurality of smart devices distributed or servers centralized systems, wherein the plurality of smart devices distributed or servers centralized systems being configured to receive pseudonymous identity of the verified harmful information, locally take the action required and notify the identified Social media platform after taking the recommended action against verified harmful information; and
wherein smart devices distributed or servers centralized systems deleting the verified harmful content in a privacy compliant way that the receiver of the digitally secure privacy proofs from secure self-verification does not learn who had the content and who did not, but just knows that the system is now compliant and may also be digitally verified later as well.

4. The system as claimed in claim 1, wherein in order to delete the verified harmful information across social media ecosystem so as to prevent spreading of the verified harmful information, the unified social media platforms exchange subsystem is configured to produce “Privacy Preserving Time bound compliance proof” for platforms, by being designed to:
share the harmful information to the law enforcement subsystem, wherein the law enforcement subsystem is configured to:
request the social media ecosystem to identify the verified harmful information stored in the blacklisted harmful information database within the social media ecosystem;
instruct the social media ecosystem to delete the verified harmful information identified from the social media ecosystem within a predefined duration; and
wherein social media platform may securely self-verify without leak of any additional information getting digital privacy preserving proofs from its content handling software either at the client devices or at the server of execution of recommended action against harmful content, which may be shared with the verifier.

5. The system as claimed in claim 1, wherein in order to notify time-stamp details of the verified harmful information to the legally authorized entity, the unified social media platforms exchange subsystem is configured to produce “Privacy Preserving Proof of initial origination platform and time” across platforms, by being designed to:
share the blacklisted harmful information database to the law enforcement subsystem, wherein the law enforcement subsystem is configured to:
request the identified social media platforms to identify the time-stamp details of the verified harmful information;
instruct the identified social media platform to share identified time-stamp details of the verified harmful information; and
identify the platform of initial harmful information origin, by comparing the origin time across all the proofs submitted by the platforms, which may be securely self-verified by authorized entities and generate “Privacy Preserving Proof of initial origination platform and time”.

6. The system as claimed in claim 1, wherein in order to notify the stored pseudonymous identity of the originator in relation to the verified harmful information to one of the law enforcement subsystem and judiciary subsystem, the unified social media platforms exchange subsystem is configured to produce “Secure Proof of Pseudonymous Identity of Originator” by being design to:
prove to the identified originating social media platform that it is the originator of the verified harmful information using Privacy Preserving Proof of initial origination platform and time;
request the identified originating Social media platform to share identified pseudonymous identity of the originator to the authorized subsystem after validating privacy preserving proofs from relevant subsystems; and
share the pseudonymous identity of the originator of the harmful content by the social media platform's authorized subsystem to the law enforcement subsystem and the judiciary subsystem as a Secure Proof of Pseudonymous Identity of Originator, which may be a regular or an oblivious transfer and may be generated by Secure self-verification process by authorized entities.

7. The system as claimed in claim 1, wherein in order to notify the stored personally identifiable information in relation to the verified harmful information to one of the law enforcement subsystem and judiciary subsystem, the unified social media platforms exchange subsystem is configured to produce “Secure proof of Personally Identifiable Information of originator” by being designed to:
prove to the identified originating social media platform using ‘Privacy Preserving Proof of initial origination platform and time’ and ‘Secure Proof of Pseudonymous Identity of Originator’; and
instruct the identified social media platform to share identified personally identifiable information to the law enforcement subsystem and the judiciary subsystem after validating privacy preserving proofs from relevant subsystems;
wherein the identified social media platform validates the produced proofs and on confirmation shares the “Secure proof of Personally Identifiable Information of originator”, which may be a regular or an oblivious transfer that may be generated and securely self-verified by an authorized entity.

8. The system as claimed in claim 1, wherein the social media platform comprises an end-to-end encrypted messaging platform, social media platform and an internet-based Social media platforms for creating and sharing the information across a plurality of information sharing system across a plurality of countries.

9. The system as claimed in claim 1, wherein the pseudonymous identity of the shared information comprises a representation of the information stored with pseudonymous identity and shared information subsystem, wherein the representation of information include one of a hash of the information which is a natural fingerprint of the information or an encrypted representation or a cryptographic commitment with hiding and binding property.

10. The system as claimed in claim 1, wherein prevention of spread of harmful information and identification of originator of harmful content across information sharing ecosystem is achieved using subsystems designed with privacy preserving technologies like Zero Knowledge Proof system, Secure Multi Party Compute, Cryptographic Commitment Schemes, Verifiable claims, Oblivious transfer, Secure enclaves, pseudonymous identity, decentralized identity and secure communications for online platforms, while protecting user privacy, preventing leak on any information to unintended parties even in case of collusion of multiple dishonest parties, wherein the system is agnostic to the type of database, cipher and hashing protocols.

11. A method of operating unified social media ecosystem with self-verification and privacy preserving proofs, comprising:
storing, by a user identity mapping subsystem, a personally identifiable information and a pseudonymous identity associated with registered users upon registration in a corresponding social media platform;
capturing, by a pseudonymous identity and shared information subsystem, a pseudonymous cryptographic commitment, either centrally or distributed method, where some of the attributes may be a pseudonymous identity of an originator of an information in the Social media platform, and a pseudonymous identity of each information, time stamp of information sharing, current status of the shared content as per compliance requirement and information of the external platform if it is an external share, upon sharing the information on the social media platform;
recording, by a harmful content reporting subsystem, anonymously reporting harmful information by a reporter without knowing any information about originator or circulating platforms;
verifying, by a harmful content verification subsystem, a reported harmful information by single or multiple verifiers without knowledge of originator or reporter upon receiving confirmation that the message was shared within social media platforms;
characterised in that
identifying, by a unified social media platforms exchange subsystem, the social media platform reported for circulation of harmful information based on the captured pseudonymous identity of the verified harmful information;
deleting, by the unified social media platforms exchange subsystem, the verified harmful information across a corresponding identified Social media platform;
deleting or taking other recommended action, by the unified social media platforms exchange subsystem, the verified harmful information across social media ecosystem so as to prevent spreading;
notifying, by the unified social media platforms exchange subsystem, time-stamp details of the verified harmful information to law enforcement subsystem;
notifying, by the unified social media platforms exchange subsystem, the stored pseudonymous identity as well as the stored personally identifiable information of the originator in relation to the verified harmful information to the law enforcement subsystem and judiciary subsystem; and
proving, by the unified social media platforms exchange subsystem, enabling Secure self-verification by authorized entities, resulting in generation of Privacy Preserving Proofs, which may be generated and verified automatically in a trustworthy way, without leaking any other information during the entire process, even in case of collusion.

12. The method as claimed in claim 11, wherein identifying, by the unified social media platforms exchange subsystem, the social media platform of the verified harmful information, resulting in ‘Privacy Preserving Proof of Sharing of Content’, comprises of:
receiving, by the unified social media platforms exchange subsystem, the pseudonymous identity of the verified harmful information from the harmful content verification subsystem;
requesting by the unified social media platforms exchange subsystem, the social media platform to confirm sharing of the verified harmful information by comparing the pseudonymous identity of the verified harmful information with the pseudonymous identities of all the information shared by the Social media platform;
adding, by the unified social media platforms exchange subsystem, the verified harmful information in a blacklisted harmful information database;
sharing, by the unified social media platforms exchange subsystem, the blacklisted harmful information database with the law enforcement subsystem; and
verifying by the unified social media platforms exchange subsystem, secure self-verification of the proof and generating Privacy Preserving Proof of Sharing of Content without leak of any privacy information to the verifier.

13. The method as claimed in claim 11, wherein deleting or flagging, by the unified social media platforms exchange subsystem, the verified harmful information across a corresponding identified social media platforms, resulting in ‘Privacy Preserving Proof of action on harmful content’, comprises:
instructing, by the unified social media platforms exchange subsystem, the corresponding identified social media platforms to delete or flag the verified harmful information from the identified Social media platform,
detecting, by the identified social media platform, the verified harmful information in the identified social media platform by comparing the pseudonymous identity of the verified harmful information with the pseudonymous identities of all the information shared; and
deleting or flagging, by the identified social media platform, the verified harmful information, after matching of pseudonymous identity of the verified harmful information, in a plurality of smart devices distributed or servers centralized systems, enabling secure self-verification, proof generation and confirming compliance without revealing any additional information to the platform.

14. The method as claimed in claim 11, wherein deleting or flagging, by the unified social media platforms exchange subsystem, the verified harmful information across social media ecosystem, resulting in ‘Privacy Preserving Time bound compliance proof’, comprises:
sharing, by the unified social media platforms exchange subsystem, the blacklisted harmful information database to the law enforcement subsystem;
requesting, by a law enforcement subsystem, the social media ecosystem to identify the verified harmful information stored in the blacklisted harmful information database within the social media ecosystem using its pseudonymous identity and pseudonymous identity of its possible predictable variants; and
instructing, by a law enforcement subsystem, the social media ecosystem to delete or flag the verified harmful information identified and its predictable variants from the social media ecosystem within a predefined duration based on categorization of content and enabling Secure self verification by authorized entities and generation of Privacy Preserving Time bound compliance proof.

15. The method as claimed in claim 11, notifying, by the unified social media platforms exchange subsystem, the time-stamp details of the verified harmful information to law enforcement subsystem, resulting in ‘Privacy Preserving Proof of initial origination platform and time’, comprises:
sharing, by the unified social media platforms exchange subsystem, the blacklisted harmful information database to the law enforcement subsystem;
requesting, by the law enforcement subsystem, the identified Social media platform to identify the first origin time-stamp details of the verified harmful information; and
instructing, by the law enforcement subsystem, the identified social media platform to share identified first origin time-stamp details of the verified harmful information by each platform;
identifying the platform of initial harmful information origin, by comparing the origin time across all the proofs submitted by the platforms, enabling Secure Self verification by authorized entities and generate “Privacy Preserving Proof of initial origination platform and time”.

16. The method as claimed in claim 11, wherein notifying, by the unified social media platforms exchange subsystem, the stored pseudonymous identity of the originator to the law enforcement subsystem, resulting in ‘Secure Proof of Pseudonymous Identity of Originator’, comprises:
sharing, by the unified social media platforms exchange subsystem, the blacklisted harmful information database to the law enforcement subsystem and the judiciary subsystem;
requesting, the law enforcement subsystem and the judiciary subsystem, the identified social media platform to identify the stored pseudonymous identity of the originator in relation to the verified harmful information; and
securely self-verifying, by the law enforcement subsystem and the judiciary subsystem, the identified first social media platform to generate Secure Proof of Pseudonymous Identity of Originator identifying pseudonymous identity of the originator to the law enforcement subsystem and the judiciary subsystem after verifying digital proofs from all necessary parties without leaking any other information.

17. The method as claimed in claim 11, wherein notifying, by the unified social media platforms exchange subsystem, the stored personally identifiable information to the law enforcement subsystem and judiciary subsystem, resulting in ‘Secure proof of Personally Identifiable Information of originator’ comprises:
sharing, by the unified social media platforms exchange subsystem, the blacklisted harmful information database to the law enforcement subsystem and the judiciary subsystem;
requesting, by the law enforcement subsystem and the judiciary subsystem, the identified social media platform to identify the stored personally identifiable information in relation to the verified harmful information and its originator pseudonymous identity; and
disclosing, by the social media platform to the law enforcement subsystem and the judiciary subsystem, the identified personally identifiable information following secure self-verification, as a Secure proof of Personally Identifiable Information of originator, to the law enforcement subsystem and the judiciary subsystem either as normal or oblivious transfer.

18. The method as claimed in claim 11, wherein storing, by the user identity mapping subsystem, a personally identifiable information and a pseudonymous identity associated corresponding to the social media platform comprising an end-to-end encrypted messaging platform, social media platform and an internet-based Social media platforms for creating and sharing the information across a plurality of information sharing system in a jurisdiction.

19. The method as claimed in claim 11, wherein prevention of spread of harmful information and identification of originator of harmful content across information sharing ecosystem is achieved using methods designed with privacy preserving technologies like Zero Knowledge Proof, Secure Multi Party Compute, Cryptographic Commitment Schemes, Verifiable claims, Oblivious transfer, Secure enclaves, pseudonymous identity, decentralized identity and secure communications for online platforms, while protecting user privacy, preventing leak on any information to unintended parties even in case of collusion of multiple dishonest parties and the method is agnostic to the type of database, cipher and hashing protocols.
